(19) United States
(12) Patent Application Publication
(10) Pub. No.: US 2007/0189039 A1
(43) Pub. Date: Aug. 16, 2007

(54) Light guide plate, mold for forming light guide plate, and method for manufacturing a mold for forming light guide plate

(75) Inventor: Kei Yokota, Higashi-chikuma-gun-Yamagata-Mura (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/704,789

(22) Filed: Feb. 9, 2007

(30) Foreign Application Priority Data
Feb. 10, 2006 (JP) 2006-033348
Dec. 20, 2006 (JP) 2006-343137

(51) Int. Cl. F21V 7/04

(52) U.S. Cl. 362/619

(57) ABSTRACT

The present invention provides a light guide plate including: a lateral surface from which light from a light source enters; a light emission surface from which the light is emitted; and a light reflecting surface reflecting the light. In the light guide plate, at least one of the light emission surface and the light reflecting surface includes: a plurality of first light diffusing portions for diffusing the light, which are formed in either one of a concave and convex shape in a thickness direction of the light guide plate; and a second light diffusing portion that is formed having a uniform surface roughness over an entire surface between a plurality of the first light diffusing portions.

### CROSS-REFERENCE TO RELATED APPLICATIONS

The present application claims priority upon Japanese Patent Application No. 2006-33348 filed on Feb. 10, 2006, and Japanese Patent Application No. 2006-343137 filed on Dec. 20, 2006, which are herein incorporated by reference.

### BACKGROUND

1. Technical Field

The present invention relates to light guide plates used in lighting devices provided in various display devices such as liquid crystal displays, wherein light from a light source enters from a lateral surface, and which include a light emission surface from which the light is emitted and a light reflecting surface reflecting the light, molds for forming light guide plates, methods for manufacturing molds for forming light guide plates, and methods for manufacturing light guide plates. The present invention particularly relates to light guide plates, molds for forming the light guide plates, and methods for manufacturing the molds for forming the light guide plates, which can improve emission efficiency of light from a light source.

2. Related Art

Recently, various display devices such as liquid crystal displays, which are widely used in televisions or personal computers, are provided with lighting devices such as so-called backlights for the purpose of securing the brightness required for images that are actually displayed to display the images clearly. Such lighting devices are generally configured with a light source for emitting light and a light guide plate for guiding light emitted from the light source to a display device side.

In such lighting devices, for example, a structure is adopted in which light emitted by the light source enters the light guide plate from a lateral surface thereof, and while the light is emitted from a surface of the light guide plate on the display device side (hereinafter referred to as a “light emission surface”), the light is repeatedly reflected by a surface of the light guide plate on the side opposite to the display device (hereinafter referred to as a “light reflecting surface”) until it finally is emitted from the light emission surface to the outside.

Here, if the light emission surface of the light guide plate is formed as a flat mirror-finished surface over its entire surface, a large portion of the light from the light source is totally reflected at the boundary surface between the light emission surface and the outside air, and therefore irradiation efficiency with respect to the display device (that is, the efficiency of the emission from the light guide plate) decreases. For this reason, generally, techniques are employed in lighting devices to improve emission efficiency by forming a large number of minute irregularities on the light emission surface or the light reflecting surface of the light guide plate so as to change the light path in the light guide plate.

Generally, a mold for forming a light guide plate is used to manufacture such a light guide plate. As a method for manufacturing a mold for forming the light guide plate, the method described below is known. That is to say, a method is known for manufacturing a mold for forming a light guide plate by injection molding a light guide plate, which causes the light entering from a lateral surface thereof to be emitted from a light emission surface that is different from the lateral surface, the method including first through third steps.

In the first step, a processed surface of a plate-shaped member (material) to be used for forming the light emission surface is etched to form a plurality of depressions. In the second step, the processed surface is subjected to blasting to roughen the region including the inner surface of the depressions of the processed surface. In the third step, the processed surface is polished such that part of the region of the processed surface other than the inner surface of the depressions is selectively mirror-finished. Supposedly, the light guide plate manufactured by using a mold for forming a light guide plate manufactured in this manner has a configuration that can improve the light emission efficiency from the light emission surface (see for example JP-A-2004-216705).

### SUMMARY

However, in the mold for forming a light guide plate manufactured with the conventional manufacturing method disclosed in JP-A-2004-216705, since part of the region other than the internal surface of the depressions of the processed surface is mirror-finished, in the manufactured light guide plate, part of the light that enters the light guide plate from the light source and travels towards for the light emission surface is totally reflected by the mirror-finished portion, which makes it difficult to improve the light emission efficiency further in a controlled stable manner.

An advantage of some aspects of the present invention is that it is possible to provide a light guide plate capable of stably improving emission efficiency of light from a light source, a mold for forming the light guide plate, a method for manufacturing the mold for forming the light guide plate, and a method for manufacturing the light guide plate.

An aspect of the invention is a light guide plate including a lateral surface from which light from a light source enters; a light emission surface from which the light is emitted; and a light reflecting surface reflecting the light, wherein at least one of the light emission surface and the light reflecting surface includes: a plurality of first light diffusing portions for diffusing the light, which are formed in either one of a concave and convex shape in a thickness direction of the light guide plate; and a second light diffusing portion that is formed having a uniform surface roughness over an entire surface between a plurality of the first light diffusing portions.

Other features of the present invention will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is an exploded perspective view showing an exemplary configuration of a light guide plate unit;

FIG. 2 is a side view showing an exemplary configuration of a light guide plate unit;

FIG. 3 is an explanatory diagram of the shape of a light guide plate of a first comparative example;

FIG. 4 is an explanatory diagram of the shape of a light guide plate of a second comparative example;

FIG. 5 is an explanatory diagram of a light path in the vicinity of a diffusing dot;

FIG. 6 is an explanatory diagram of the brightness distribution of the second comparative example;

FIG. 7 is an explanatory diagram of the shape of a light guide plate and brightness distribution in a third comparative example;

FIG. 8A and FIG. 8B are explanatory diagrams of restrictions upon etching;

FIG. 9 is a front view of a light reflecting surface of a light guide plate;

FIG. 10 is a cross-sectional view taken along the line A-A in FIG. 9;

FIG. 11 is an enlarged view of the region marked “M” in FIG. 9;

FIG. 12 is a graph showing the relation between an area ratio R and a distance L from a light source 106;

FIG. 13 is an explanatory diagram of a rough surface on a light emission surface side of a light guide plate;

FIG. 14A to FIG. 14E are diagrams showing manufacturing steps of a mold for forming a light guide plate used for manufacturing a light guide plate;

FIG. 15 is a diagram illustrating how dressing is carried out;

FIG. 16 is a diagram illustrating a manufacturing step of a light guide plate;

FIG. 17 is a diagram illustrating a manufacturing step of a light guide plate;

FIG. 18 is a side view showing a manufactured light guide plate;

FIG. 19A and FIG. 19B are explanatory diagrams of the shape of a diffusing dot 111;

FIG. 20 is a side view showing another light guide plate;

FIG. 21 is a graph showing the relation between brightness and relative position of an ordinary light guide plate;

FIG. 22 is a graph showing the relation between brightness and relative position of an ordinary light guide plate;

FIG. 23 is a graph showing the relation between brightness and relative position of a light guide plate of an embodiment of the present invention;

FIG. 24 is a graph showing brightness uniformity and average brightness of a light guide plate; and

FIG. 25 is a table showing test results of brightness uniformity and average brightness.

### DESCRIPTION OF EXEMPLARY EMBODIMENTS

At least the following matters will be made clear by the explanation in the present specification and the description of the accompanying drawings.

In order to address the above-described problems, a light guide plate of the present embodiment is a light guide plate to which light from a light source enters from a lateral surface thereof, and has a light emission surface from which the light is emitted and a light reflecting surface reflecting the light, wherein at least one of the light emission surface and the light reflecting surface includes a plurality of first light diffusing portions for diffusing the light, that are formed in either one of a concave and convex shape in a thickness direction of the light guide plate and as a dot pattern in a surface direction, and a second light diffusing portion that is formed over an entire surface between a plurality of the first light diffusing portions so as to have a substantially uniform surface roughness.

In the present invention, at least one of the light emission surface and the light reflecting surface of the light guide plate includes a plurality of first light diffusing portions in either one of a concave and convex shape for diffusing light and a second light diffusing portion formed over an entire surface between a plurality of the first light diffusing portions so as to have a substantially uniform surface roughness.

In this manner, light that enters the light guide plate is emitted to the light emission side as a result of being diffused by a plurality of first light diffusing portions and the second light diffusing portion formed between the first light diffusing portions. Therefore, compared with a conventional light guide plate including a rough surface and a mirror surface, the emission efficiency of light from a light source can be stably improved.

Either one of concave and convex surfaces of a plurality of the first light diffusing portions of the light guide plate of the present embodiment are respectively roughened so as to have a plurality of minute irregularities.

In the present embodiment, since either one of concave and convex surfaces of a plurality of first light diffusing portions are respectively roughened so as to have a plurality of minute irregularities, light incident on the light guide plate can be diffused efficiently.

A plurality of the first light diffusing portions of the light guide plate of the present embodiment are formed such that a density of the first light diffusing portions per unit area increases from a closer side to a distant side with respect to the light source.

In the present embodiment, since the density of a plurality of first light diffusing portions per unit area increases from a closer side to a distant side with respect to the light source, the amount of light that is emitted from the vicinity of the light source and that from a portion distant therefrom can be made uniform, and so-called uneven brightness can be suppressed.

A plurality of the first light diffusing portions of the light guide plate of the present embodiment are, when viewed in the plate thickness direction, formed in a circular shape having a diameter in the range of substantially 0.1 mm to substantially 0.5 mm, and a height of the vertex with respect to a surface on which the first light diffusing portions are formed in the range of substantially 0.02 mm to substantially 0.1 mm.

In the present embodiment, since a plurality of first light diffusing portions have a circular shape designed subject to the above numerical value range, it becomes possible to easily improve the emission efficiency by the first light diffusing portions, while allowing for flexibility in designing a pattern of the first light diffusing portions of the light guide plate.

The second light diffusing portion of the light guide plate of the present embodiment is formed so as to have a surface roughness Ra of substantially equal to or less than 10 μm.

In the present embodiment, since the second light diffusing portion is formed to have a surface roughness Ra of substantially equal to or less than 10 μm, the second light diffusing portion of the light guide plate can be formed in a uniform manner. At the same time, it becomes possible to easily design a pattern of the first light diffusing portions based on the surface roughness Ra of the second light diffusing portion, while attempting to improve the emission efficiency by the second light diffusing portion.

A mold for forming a light guide plate of the present embodiment is for use in injection molding of a light guide plate to which light from a light source enters from a lateral surface thereof, and has a light emission surface from which the light is emitted and a light reflecting surface reflecting the light, wherein a processed surface to be used for forming at least the light reflecting surface includes a plurality of first light diffusing portion forming dots that are formed in either one of a concave and convex shape in a direction perpendicular to a surface direction and as a pattern in the surface direction and, a second light diffusing portion forming rough surface that is formed over an entire surface of the processed surface between the first light diffusing portion forming dots so as to have a substantially uniform surface roughness.

In the present embodiment, on the processed surface to be used for forming at least the light reflecting surface of the light guide plate, a plurality of first light diffusing portion forming dots having either one of a concave and convex shape for diffusing light, and the second light diffusing portion forming rough surface formed over an entire surface between a plurality of the first light diffusing portion forming dots so as to have a substantially uniform surface roughness are formed.

In this manner, light that enters on the light guide plate formed using the mold for forming a light guide plate is emitted to the light emission side as a result of being diffused by a plurality of first light diffusing portions formed by a plurality of first light diffusing portion forming dots, and the second light diffusing portion formed by the second light diffusing portion forming rough surface. Therefore, it becomes possible to manufacture the light guide plate capable of improving the emission efficiency of light from a light source in a stable manner, compared with a conventional mold for forming a light guide plate that includes a rough surface and a mirror-finished surface.

Either one of the concave and convex surfaces of the first light diffusing portion forming dots of the mold for forming a light guide plate of the present embodiment are respectively roughened so as to have a plurality of minute irregularities

In the present embodiment, since either one of concave and convex surfaces of a plurality of first light diffusing portion forming dots are respectively roughened so as to have a plurality of minute irregularities, it becomes possible to diffuse incident light in an efficient manner by first light diffusing portions of the light guide plate formed by the first light diffusing portion forming dots, compared with a so-called mirror-surfaced surface.

The first light diffusing portion forming dots of the mold for forming a light guide plate of the present embodiment are formed such that a density on the processed surface of the first light diffusing portion forming dots gradually increases from one end side of the processed surface to the other end side thereof.

In the present embodiment, since the density of a plurality of first light diffusing portion forming dots on the processed surface gradually increases from one end side of the processed surface to the other end thereof, in the light guide plate formed using the mold, the amount of light that is emitted from the vicinity of the light source and that from a portion distant therefrom can be made uniform, and so-called uneven brightness can be suppressed.

The first light diffusing portion forming dots of the mold for forming a light guide plate of the present embodiment are formed, when viewed in a direction perpendicular to the processed surface, in a circular shape having a diameter in the range of substantially 0.1 mm to substantially 0.5 mm and a height of the vertex with respect to the processed surface in the range of substantially 0.02 mm to substantially 0.1 mm.

In the present embodiment, since a plurality of first light diffusing portion forming dots for forming a plurality of first light diffusing portions of the light guide plate have a circular shape designed subject to the above numerical value range, it becomes possible to easily improve the emission efficiency by the first light diffusing portions in the light guide plate manufactured using the mold for forming a light guide plate of the present embodiment.

The second light diffusing portion forming rough surface of the mold for forming a light guide plate of the present embodiment is formed so as to have a surface roughness Ra of substantially equal to or less than 10 μm.

In the present embodiment, since the second light diffusing portion forming rough surface for forming the second light diffusing portion is formed so as to have a surface roughness Ra of substantially equal to or less than 10 μm, the second light diffusing portion of the light guide plate formed using the second light diffusing portion forming rough surface can be formed in a uniform manner. At the same time, it becomes possible to easily design a pattern of the first light diffusing portions based on the surface roughness Ra of the second light diffusing portion, while attempting to improve the emission efficiency by the second light diffusing portion.

The method for manufacturing a mold for forming a light guide plate of the present embodiment is for manufacturing a mold for use in injection molding of a light guide plate to which light from a light source enters from a lateral surface thereof, and has a light emission surface from which the light is emitted and a light reflecting surface reflecting the light, with the method including forming a plurality of either one of concave and convex dots in a direction perpendicular to a surface direction by etching or casting on a surface of a metallic base material to be used for forming at least the light reflecting surface, and forming a rough surface having a substantially uniform surface roughness by grinding or blasting over an entire surface between a plurality of the dots.

In the present embodiment, a plurality of dots in either one of a concave and convex shape are formed by etching or casting on the surface of a metallic base material to be used for forming at least the light reflecting surface of the light guide plate, and the rough surface is formed that has a substantially uniform surface roughness by grinding or blasting process over an entire surface between a plurality of the dots.

In this manner, it is possible to obtain a mold for forming a light guide plate with a plurality of dots and a rough surface being formed on the surface thereof. It becomes possible by using the mold for forming a light guide plate to manufacture a light guide plate capable of stably improving the emission efficiency of incident light.

The method for manufacturing a light guide plate of the present embodiment includes performing injection molding of a light guide plate using a mold for forming a light guide plate manufactured by the above-described method for manufacturing a mold for forming a light guide plate.

In the present embodiment, by injection molding using a mold for forming a light guide plate manufactured by the above-described method for manufacturing a mold for forming a light guide plate, it becomes possible to obtain a light guide plate capable of stably improving the emission efficiency of incident light.

A light guide plate is provided including: a lateral surface from which light from a light source enters; a light emission surface from which the light is emitted; and a light reflecting surface reflecting the light, wherein at least one of the light emission surface and the light reflecting surface includes: a plurality of first light diffusing portions for diffusing the light, which are formed in either one of a concave and convex shape in a thickness direction of the light guide plate; and a second light diffusing portion that is formed having a uniform surface roughness over an entire surface between a plurality of the first light diffusing portions.

With such a light guide plate, the emission efficiency of light from a light source can be stably improved.

Also, it is preferable that the first light diffusing portions are convex and their height is greater than the surface roughness of the second light diffusing portion. In this manner, the first light diffusing portion can be prevented from being buried in the rough surface of the second light diffusing portion, and therefore it is possible to emit a predetermined amount of light by the first light diffusing portion.

Also, it is preferable that the second light diffusing portion includes either one of concave and convex streaks extending in a direction perpendicular to a light guide direction. In this manner, the emission efficiency can be improved.

A mold is provided for forming a light guide plate including a lateral surface from which light from a light source enters, and a light emission surface from which the light is emitted, and a light reflecting surface reflecting the light, wherein a surface for forming at least one of the light emission surface and the light reflecting surface includes a plurality of first light diffusing portion forming dots formed in either one of a concave and convex shape in a direction perpendicular to a surface direction so as to form in the light guide plate first light diffusing portions for diffusing the light and, a second light diffusing portion forming rough surface having a uniform surface roughness formed over an entire surface between the first light diffusing portion forming dots so as to form a second light diffusing portion between the first light diffusing portions of the light guide plate.

With such a mold, it is possible to form a light guide plate capable of improving the emission efficiency of light from a light source in a stable manner.

It is preferable that the first light diffusing portion forming dots are concave and their depth is greater than the surface roughness of the second light diffusing portion forming rough surface. In the light guide plate formed using such a mold, the first light diffusing portion can be prevented from being buried in the rough surface of the second light diffusing portion, and therefore it is possible that a predetermined amount of light is emitted by the first light diffusing portion.

It is preferable that either one of concave and convex streaks are formed on the second light diffusing portion forming rough surface, the streaks extending in a direction perpendicular to a light guide direction in the light guide plate. In the light guide plate formed using such a mold, the emission efficiency can be improved.

It is preferable that the second light diffusing portion forming rough surface is formed by a grinding process after the first light diffusing portion forming dots have been formed by etching. In this manner, it is possible to easily manufacture a mold for forming the second light diffusing portion between the first light diffusing portions of the light guide plate.

A method is provided for manufacturing a mold for forming a light guide plate having a lateral surface from which light from a light source enters, a light emission surface from which the light is emitted, and a light reflecting surface reflecting the light, the method including: forming a plurality of either one of concave and convex first light diffusing portion forming dots in a direction perpendicular to a surface direction, in order to form first light diffusing portions for diffusing the light in the light guide plate, and forming a second light diffusing portion forming rough surface having a uniform surface roughness over an entire surface between the first light diffusing portion forming dots, in order to form a second light diffusing portion between the first light diffusing portions of the light guide plate.

With such a method for manufacturing a mold, it is possible to manufacture a mold for forming a light guide plate capable of improving the emission efficiency of light from a light source in a stable manner.

It is preferable that the first light diffusing portion forming dots are concave and their depth is greater than the surface roughness of the second light diffusing portion forming rough surface. In the light guide plate formed using such a mold, the first light diffusing portion can be prevented from being buried in the rough surface of the second light diffusing portion, and therefore it is possible that a predetermined amount of light is emitted by the first light diffusing portion.

It is preferable that forming the second light diffusing portion forming rough surface is performed by forming either one of concave and convex streaks extending in a direction perpendicular to a light guide direction in the light guide plate. With the light guide plate formed using such a mold, the emission efficiency can be improved.

It is preferable that a step of forming the second light diffusing portion forming rough surface by a grinding process is performed after forming a plurality of the first light diffusing portion forming dots has been performed by etching. In this manner, it is possible to easily form a mold for forming the second light diffusing portion between the first light diffusing portions of the light guide plate.

It is preferable that a cut depth in the grinding process is shallower than a depth of the first light diffusing portion forming dots. In the light guide plate formed using such a mold, the first light diffusing portion can be prevented from being buried in the rough surface of the second light diffusing portion, and therefore it is possible that a predetermined amount of light is emitted by the first light diffusing portion.

It is preferable that a cut depth in dressing a grinding wheel used for the grinding process is shallower than a depth of the first light diffusing portion forming dots. In the light guide plate formed using such a mold, the first light diffusing portion can be prevented from being buried in the rough surface of the second light diffusing portion, and therefore it is possible that a predetermined amount of light is emitted by the first light diffusing portion.

A method is provided for manufacturing a light guide plate to which light from a light source enters from a lateral surface thereof, and has a light emission surface from which the light is emitted and a light reflecting surface reflecting the light, the method including manufacturing a mold by forming a plurality of either one of concave and convex first light diffusing portion forming dots in a direction perpendicular to a surface direction, in order to form first light diffusing portions for diffusing the light in the light guide plate, and a second light diffusing portion forming rough surface having a uniform surface roughness over an entire surface between a plurality of the first light diffusing portion forming dots, in order to form a second light diffusing portion between the first light diffusing portions of the light guide plate, and manufacturing a light guide plate using the mold.

With such a method for manufacturing a light guide plate, it is possible to manufacture a light guide plate capable of improving the emission efficiency of light from the light source in a stable manner.

### EMBODIMENT

### Overall Configuration of the Light Guide Plate Unit

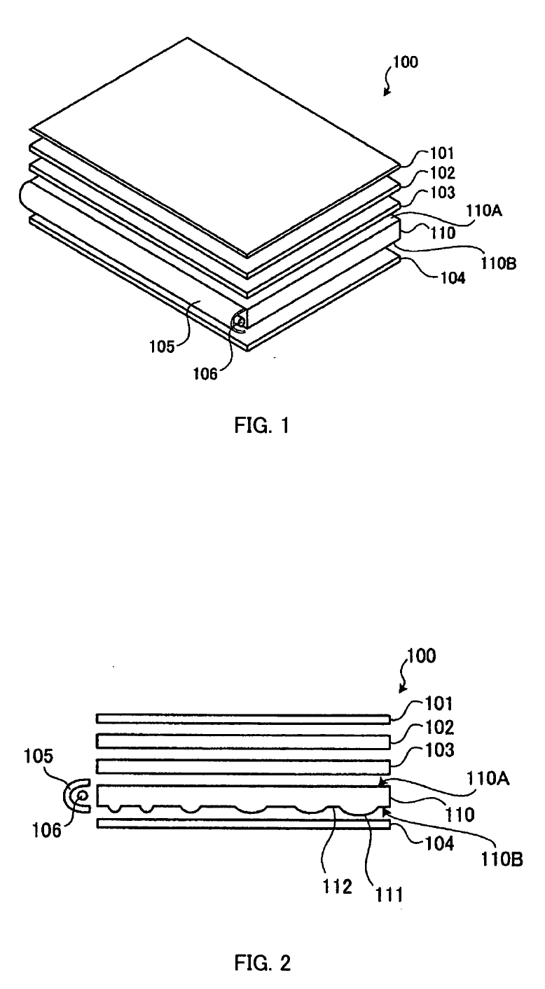

FIG. 1 is an exploded perspective view showing an exemplary configuration of a light guide plate unit that uses a light guide plate of the present embodiment. FIG. 2 is a side view showing an exemplary configuration of the light guide plate unit shown in FIG. 1. As shown in FIGS. 1 and 2, a light guide plate unit 100 is configured in a rectangular plate shape for example, and includes prism sheets 101 and 102, a diffusing sheet 103, a light guide plate 110, a reflecting sheet 104, alight source cover 105 and a light source 106.

The prism sheets 101 and 102 have, for example, a structure in which a prism made of acrylic resin is disposed on a polyester film layer, and condense light that is emitted from a light emission surface 110A side of the light guide plate 110 in the emission direction. The diffusing sheet 103 condenses light that is emitted from a light emission surface 110A side of the light guide plate 110 in the emission direction, in a similar manner as the prism sheets 101 and 102.

The reflecting sheet 104 is disposed to ensure that light that has entered the light guide plate 110 is not leaked from a light reflecting surface 110B side or a lateral surface of the light guide plate 110. The light source cover 105 is arranged to cover the light source so as to transmit light from the light source 106 via a lateral surface of the light guide plate 110 with high efficiency. The light source 106 is made of a fluorescent tube such as a cold-cathode tube or a light emitting element such as an LED (light emitting diode). The sheets 101 to 104 and the light source cover 105 are configured by various acrylic or polyethylene resin materials, for example.

The light guide plate 110 is made of a thermoplastic resin such as polycarbonate (PC), polymethylmethacrylate (PMMA), cyclic olefin copolymer (COC), or a transparent material such as glass, and has high light transmittance and low birefringence. The light guide plate 110 is formed by a processing method such as injection molding or thermal pressing, and includes the light emission surface 110A from which light that has entered the light guide plate 110 via a lateral surface thereof from the light source 106 is emitted, and the light reflecting surface 110B that reflects the light to the light emission surface 110A side.

That is, in the light guide plate unit 100 configured as described above, light from the light source 106 is emitted from the light emission surface 110A side, while being repeatedly reflected inside the light guide plate 110, and part of the light is reflected by the reflecting sheet 104 so as not to leak from the light guide plate 110. Light that has been emitted from the light emission surface 110A side passes through the diffusing sheet 103 and the prism sheets 101 and 102, and is emitted in a direction substantially perpendicular to the light reflecting surface 10B.

### SHAPE OF THE LIGHT GUIDE PLATE OF THE COMPARATIVE EXAMPLES

### First Comparative Example

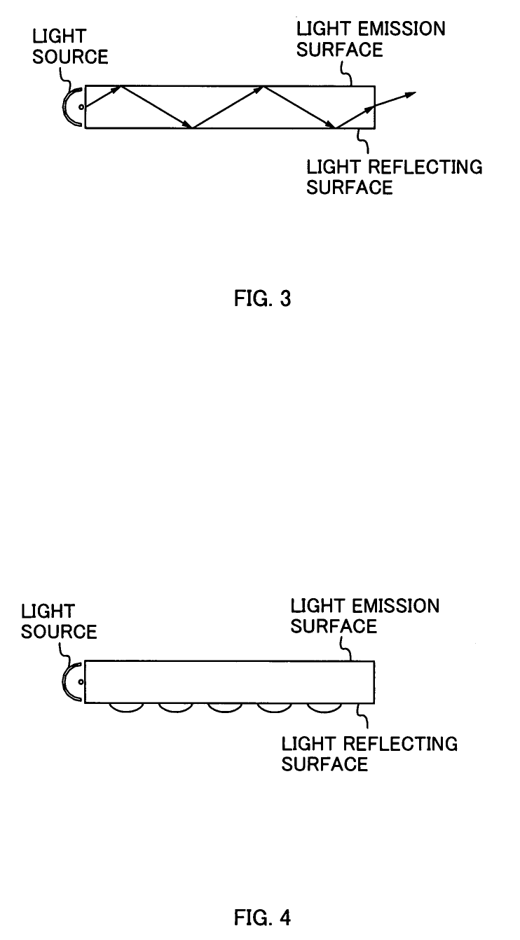

FIG. 3 is an explanatory diagram of the shape of a light guide plate of a first comparative example. In this first comparative example, a light emission surface and a light reflecting surface of the light guide plate are mirror-finished surfaces. The arrows shown inside the light guide plate in FIG. 3 illustrate the light path from the light source.

With the shape of the light guide plate of the first comparative example, light is repeatedly reflected according to Snell's law until it exits the light guide plate from the lateral surface opposite to the light source (side opposite to the light source). Therefore, with the shape of the light guide plate of the first comparative example, the light emission efficiency with which light is emitted from the light emission surface decreases.

### Second Comparative Example

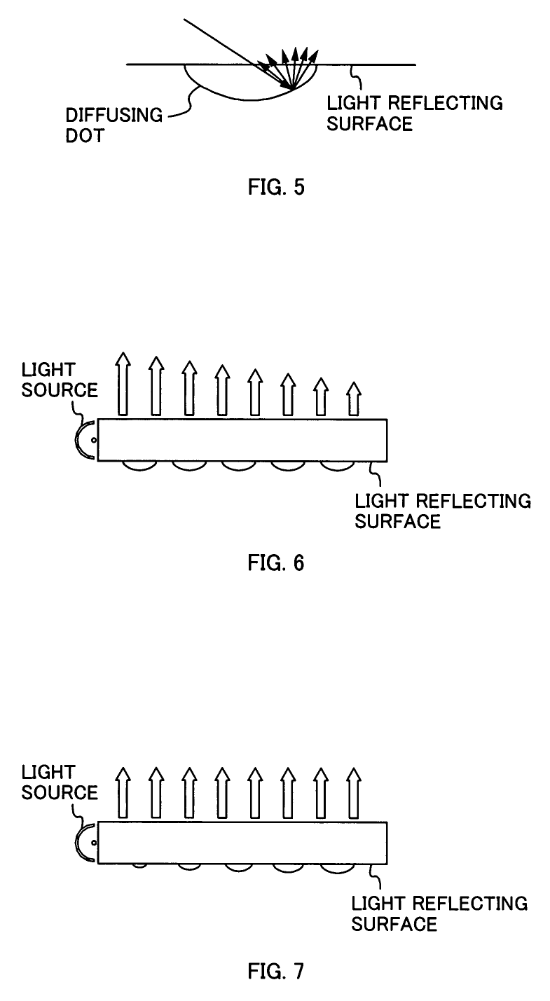

FIG. 4 is an explanatory diagram of the shape of a light guide plate of a second comparative example. In this second comparative example, circular convex diffusing dots that protrude outwardly from the light reflecting surface are uniformly formed on the light reflecting surface side of the light guide plate in an equal size and at equal intervals. FIG. 5 is an explanatory diagram of the light path in the vicinity of a diffusing dot. The surface of the diffusing dot is a rough surface. When the diffusing dot is irradiated with light, it diffuses and reflects the light. As a result, the light emission efficiency in the second comparative example improves compared with that in the first comparative example.

FIG. 6 is an explanatory diagram of the brightness distribution in the second comparative example. In the second comparative example, the diffusing dots are uniformly formed on the light reflecting surface side of the light guide plate in an equal size and at equal intervals. Therefore, a larger amount of light reaches diffusing dots close to the light source, which results in high brightness in a portion of the light emission surface close to the light source. On the other hand, little light reaches diffusing dots distant from the light source, and thus the brightness of a portion of the light emission surface distant from the light source decreases. In short, with the shape of the light guide plate of the second comparative example, the brightness on the light emission surface is not uniform.

### Third Comparative Example

FIG. 7 is an explanatory diagram of the shape of a light guide plate and brightness distribution in a third comparative example. In this third comparative example, the size of the diffusing dots is made smaller as their distance from the light source becomes smaller, and larger as their distance from the light source becomes greater. In the third comparative example, the amount of light that reaches the diffusing dots close to the light source decreases compared with the second comparative example, and the amount of light that reaches the diffusing dots distant from the light source increases compared with the second comparative example. As a result, the brightness on the light emission surface is more uniform than in the second comparative example.

In the third comparative example, the size and density of the diffusing dots need to be adjusted in order to achieve uniform brightness on the light emission surface. In this case, the design can be simpler when the size of the diffusing dot is adjusted while keeping the number of the diffusing dots per unit area constant. Accordingly, in designing a pattern of diffusing dots, the area ratio between the area corresponding to the diffusing dots and the area other than that is controlled.

The diffusing dots in the light guide plate are formed using a mold in which a dot pattern is formed by etching (described later). The dot pattern is formed in the mold by etching because diffusing dots having different sizes can be processed at one time, and also the etched surface has an appropriate roughness, which enables forming diffusing dots having an appropriate rough surface.

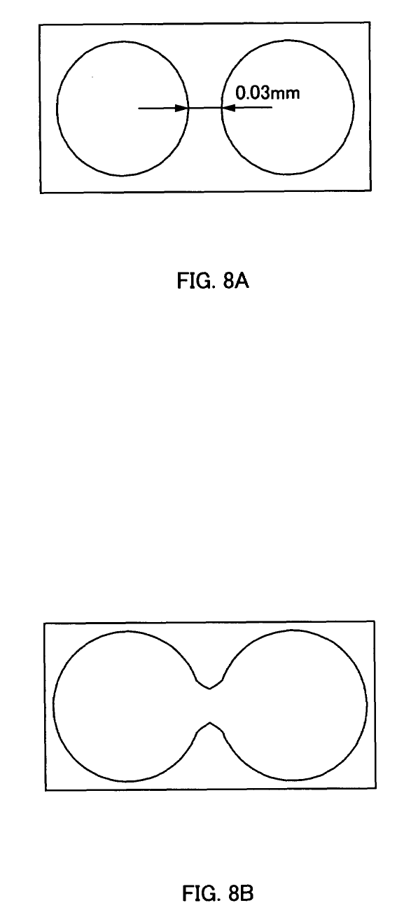

FIGS. 8A and 8B are explanatory diagrams of the restrictions on the etching process. When a dot pattern is formed by etching in a mold, the distance between dots shown in FIG. 8A cannot be less than 0.03 mm. If etching is attempted so as to adjust the distance between dots to less than 0.03 mm, diffusing dots are connected to each other as shown in FIG. 8B, resulting in a shape different from that of the designed dot pattern, and consequently, it becomes impossible to control the area ratio between the area corresponding to the diffusing dots and the area other than that. For this reason, the distance between dots is equal to or more than 0.03 mm. (For this reason, also in the embodiments described below, the distance between dots is equal to or more than 0.03 mm.)

The minimum dot diameter is also subject to restrictions in the etching process. The minimum dot diameter is 0.08 mm. If the dot diameter is set to less than 0.08 mm, diffusing dots may not be formed in the mold. (For this reason, also in the embodiments described below, the minimum dot diameter is 0.08 mm.)

Due to the above restrictions on the distance between dots, there is a limitation to the size of diffusing dot. As a result, in the light guide plate of the third comparative example, part of light attenuates without reaching the diffusing dot. Therefore, the emission efficiency of the third comparative example still can be improved. A light guide plate of an embodiment of the present invention described below adopts a configuration in which even such attenuating light is utilized to improve the emission efficiency.

### Shape of the Light Guide Plate of the Present Embodiment

The light emission surface 110A of the light guide plate 110 is, for example, a flat surface or a rough surface roughened to have a uniform roughness. The light reflecting surface 110B includes, for example, diffusing dots that serve as first light diffusing portions formed in a concave or convex shape (described later) and a rough surface that serves as a second light diffusing portion formed between these diffusing dots.

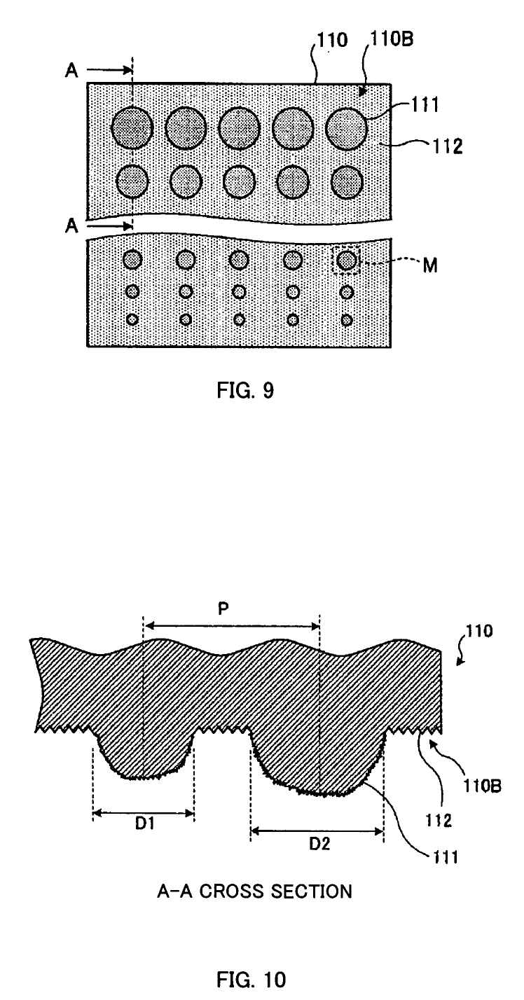

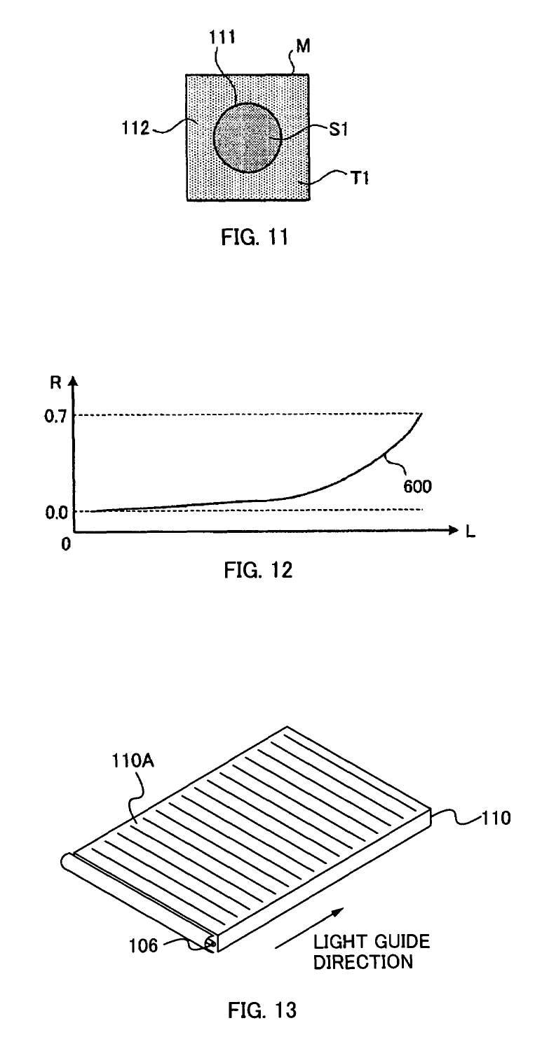

FIG. 9 is a front view of the light reflecting surface 110B of the light guide plate 110. Also, FIG. 10 is a cross-sectional view taken along the line A-A in FIG. 9. FIG. 11 is an enlarged view of the region indicated with “M” in FIG. 9. As shown in FIGS. 9 and 10, the light reflecting surface 110B of the light guide plate 110 includes a plurality of diffusing dots 111 and a rough surface 112 formed between a plurality of the diffusing dots 111.

A plurality of the diffusing dots 111 are formed in a circular convex shape that protrude outwardly from the light reflecting surface 110B. Diameters D1 and D2 of the diffusing dots 111 are respectively determined as appropriate in the range of, for example, substantially 0.1 mm to 0.5 mm. Here, the diffusing dots 111 are formed such that the diameter D1 of the diffusing dots 111 on the side close to the light source 106 is smaller than the diameter D2 of the diffusing dots 111 on the side distant from the light source 106.

The diffusing dots 111 are also formed such that they protrude from the light reflecting surface 110B by a height that gradually increases in the range of substantially 0.02 mm to substantially 0.1 mm from the closer side to the distant side with respect to the light source 106. The pitch P between the diffusing dots 111 is set to be substantially 0.03 mm at least. On the other hand, the rough surface 112 is formed over an entire surface of the light reflecting surface 110B, with a surface roughness of equal pitch with a depth of substantially 0.01 mm from the light reflecting surface 110B.

That is, the height of the diffusing dots 111 from the light reflecting surface 110B is set higher than the surface roughness of the rough surface 112. This allows a configuration that prevents the diffusing dots 111 from being buried in the rough surface 112. If the height of the diffusing dots 111 were lower than the surface roughness of the rough surface 112, the diffusing dots 111 would be buried in the rough surface 112, and diffusive reflection in all directions by the diffusing dots 111 could not be fully achieved.

The relation between the diffusing dots 111 and the rough surface 112 on the light reflecting surface 110B of the light guide plate 110 configured as described above can be obtained as follows: As shown in FIG. 11 for example, when the area of the diffusing dot 111 per predetermined region M of the light reflecting surface 110B is S1 and the unit area of the predetermined region M is T1, an area ratio R for achieving a desired light emission amount can be obtained using the expression S1/T1=R.

FIG. 12 is a graph showing the relation between the area ratio R and a distance L from the light source 106. As described so far, the relation between the area ratio R and the distance L needs to be adjusted such that the area ratio R increases as the distance L from the light source 106 increases, as indicated by the curve 600.

As described above, the distance between dots cannot be less than 0.03 mm due to restrictions on the etching process. For this reason, the maximum value of the area ratio R (=S1/T1) is approximately 0.7. In addition, the minimum dot diameter is 0.08 mm due to the restrictions on the etching process. Accordingly, the minimum value of the area ratio R is approximately 0.02. As a result, when a dot pattern is designed so as to realize uniform brightness on the light emission surface, the area ratio R is adjusted in the range of 0.02 to 0.7. In the present embodiment, a rough surface is formed on the light emission surface side and the light reflecting surface side so as to improve the emission efficiency when the area ratio R is limited as described above.

FIG. 13 is an explanatory diagram of a rough surface on the light emission surface side of the light guide plate 110.

Of the light from the light source, the light that travels in a light guide direction while being repeatedly reflected tends to fail to reach the diffusing dots and attenuate. Based on this, in the present embodiment, streak-shaped minute concave and convex portions are formed on the rough surfaces on the light emission surface and the light reflecting surface sides along a direction perpendicular to the light guide direction. Note that while several streaks are depicted on the light emission surface of the light guide plate 110 in FIG. 13 for the sake of description, in actuality, a large number of minute streaks are formed.

By forming minute concave and convex portions on the rough surface in a direction perpendicular to the light guide direction, light that fails to reach the diffusing dots 111 is diffused by the concave or convex portion on the rough surface, which improves the emission efficiency.

On the light emission surface side, such a rough surface is formed in a uniform manner. Specifically, minute concave and convex portions along a direction perpendicular to the light guide direction are formed in a uniform manner on the light emission surface side.

On the light reflecting surface side, such a rough surface is formed in a uniform manner between the diffusing dots 111. Specifically, on the light reflecting surface side, minute concave and convex portions along the direction perpendicular to the light guide direction are formed in a uniform manner between the diffusing dots 111. On the surface of the diffusing dots, only a rough surface resulted from etching (described later) is formed, and minute concave and convex portions (minute concave and convex portions along the direction perpendicular to the light guide direction) due to a grinding process (described later) are not formed.

### Method for Manufacturing the Mold for Forming the Light Guide Plate

Next, manufacturing steps of a mold for forming a light guide plate used for manufacturing the light guide plate 110 is described.

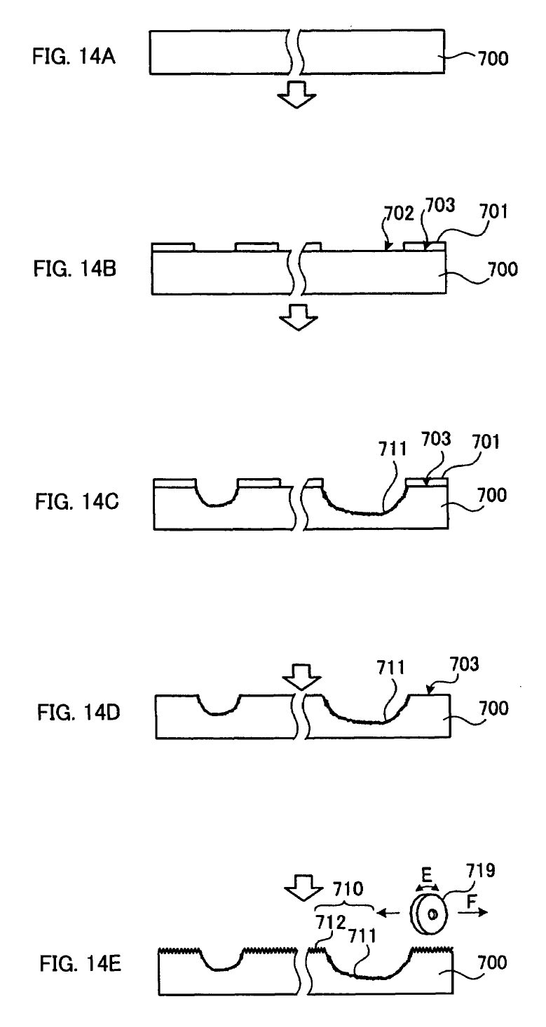

FIGS. 14A to 14E are diagrams showing manufacturing steps of a mold for forming a light guide plate used for manufacturing the light guide plate 110. In the following description, portions similar to those described so far are marked with the same reference numerals, and their further description is omitted.

As shown FIG. 14A, a light guide plate forming mold 700 that is a plate-shaped member made up of a metallic base material is prepared, and subjected to degreasing, washing and the like. As a mold material, typical steel products used for general molds can be used. Also as a mold material used in injection molding, a material having high corrosion resistance/abrasion resistance needs to be used. In the present embodiment, a STAVAX hardening material (hardness: HRC 50 to 59, approximately) manufactured by Uddeholm is used.

Next, as shown in FIG. 14B, a resist 701 is formed on a processed surface of the light guide plate forming mold 700 in a region of the surface other than the portion for forming the diffusing dots 111, so as to determine a diffusing dot formation region 702 and a rough surface formation region 703.

Then, as shown in FIG. 14C, the processed surface of the light guide plate forming mold 700 is subjected to etching, and a diffusing dot transfer depression 711 that has a minute rough surface is formed in the diffusing dot formation region 702.

Etching conditions are set here such that the diffusing dot transfer depression 711 has a hemispheric shape that has a diameter in the range of 0.11 mm to 0.47 mm and a depth in the range of 0.02 mm to 0.1 mm, for example.

As shown in FIG. 14D, the resist 701 is removed to expose the rough surface formation region 703.

Finally, as shown in FIG. 14E, the processed surface is subjected to a grinding process using a grinding wheel 719 that rotates in a direction shown by the arrow E in FIG. 14E and moves in a direction shown by the arrow F in FIG. 14E so as to form a rough surface transfer portion 712 in the rough surface formation region 703, thereby forming the light guide plate forming mold 700 with a molding surface 710 that includes the diffusing dot transfer depression 711 and the rough surface transfer portion 712.

The grinding process conditions are described below.

As the grinding process condition, for example, it is possible to use a flat-surface grinding machine, for which a general grinding wheel, a diamond grinding wheel, a CBN grinding wheel or the like can be selected as the grinding wheel 719. In the present embodiment, a general grinding wheel (No. 60: grinding particles are fused alumina/silicon carbide) was used.

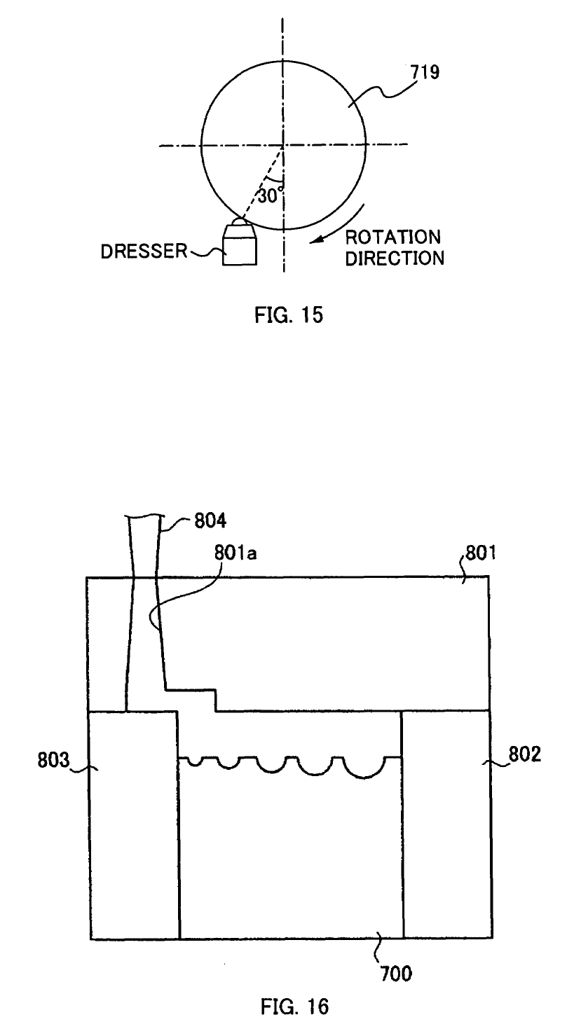

FIG. 15 is a diagram illustrating dressing. As shown in FIG. 15, a dresser is pressed against the grinding wheel 719 having a cylindrical shape at an angle of 30 degrees to process the grinding wheel 719. A grinding stone (single crystal diamond) having an acute angle (less than 90 degrees) is used for the dresser. When the surface roughness of the grinding wheel (or roughness of the processed surface of the mold) is finely adjusted, a grinding stone having an obtuse angle (equal to or more than 90 degrees) is used for the dresser. A dresser whose tip is polygonal, for example pentagonal, is used. The surface to be pressed against is preferably changed for each dressing operation. In the present embodiment, the cutting during the dressing is 0.01 mm.

The grinding process conditions for the flat-surface grinding machine may be set, for example, such that the X-axis feed rate is 20 m/min, the Y-axis feed rate is 4 mm per pitch, and the cut depth is 0.1 mm. The processed surface of the mold is parallel to the X-axis and Y-axis directions. The X-axis direction is perpendicular to the Y-axis direction. The rotational axis of the grinding wheel 719 is parallel to the Y-axis direction. That is, at the contact point where the grinding wheel 719 contacts the processed surface, the surface of the grinding wheel 719 and the processed surface move relatively to each other in the X-axis direction. Through this grinding process, streak-shaped irregularities are formed in a direction parallel to the X-axis in the rough surface transfer portion 712.

By setting the etching and grinding process conditions as described above, it is possible to manufacture a light guide plate forming mold 700 that includes a rough surface transfer portion 712 whose surface roughness Ra is approximately 8 μm±1 μm, that is, equal to or less than 10 μm. In addition, it is also possible to vary the surface roughness Ra in the range of approximately 6 μm to 14 μm by changing the cut depth for the grinding process.

The surface roughness Ra can be adjusted according to the conditions such as “X-axis feed rate and Y-axis feed rate during the grinding process”, “cut depth during the grinding process”, “dressing conditions (positional relation between grinding wheel and dresser, cut depth during dressing, and grinding speed)”, “size of grinding wheel” and “material of ground object”. In the present embodiment, the rough surface transfer portion 712 is subjected to a grinding process under uniform conditions, so that an entire surface of the rough surface transfer portion 712 is uniform.

When blasting is performed after the depressions 711 are formed, metal particles are blasted also to the surface of the depression 711 and the surface of the depressions 711 is also subjected to blasting. By contrast, in the present embodiment, the surface is subjected to the grinding process after the concave depressions 711 are formed by etching. Therefore, the grinding process can be performed on the rough surface formation region 703 (region other than the depressions 711) without grinding the surface of the depression 711. That is to say, it is possible to perform the grinding process on the rough surface formation region 703, while maintaining the rough surface formed by etching at the surface of the depressions 711.

Also in the present embodiment, the grinding process is performed under uniform conditions regardless of the distance from the light source. Therefore, it is easy to realize a uniform surface roughness in the rough surface transform portion 712, which also results in stable quality of the mold. If it were attempted to vary grinding conditions or surface roughness depending on the distance from the light source, the grinding process would become difficult and the quality of the mold would become unstable.

In the present embodiment, streak-shaped irregularities formed in the rough surface transfer portion 712 by subjecting the rough surface formation region 703 to the grinding process are suitably irregular with regard to their depth and pitch. For this reason, with a light guide plate formed using such a mold (described later), it is possible to prevent bias of bright lines and moiré effects.

The surface of the grinding wheel 719 and the processed surface of the mold (rough surface formation region 703) are moved relatively in a direction perpendicular to the light guide direction. As a result, the streak-shaped concave and convex portions formed on the rough surface transfer portion 712 contain many components that are perpendicular to the light guide direction. In this manner, with the light guide plate 110 formed using such a mold, since streak-shaped concave or convex portions are formed along a direction perpendicular to the light guide direction, the emission efficiency improves. When the processed surface of the mold is subjected to blasting, only irregularities for diffusing light in all directions are formed in the light guide plate, so that it is difficult to improve the emission efficiency.

In the present embodiment, the depth of the depressions 711 formed by etching is from 0.02 mm to 0.1 mm, which is deeper than the surface roughness of the rough surface transfer portion 712. This is because if the surface roughness of the rough surface transfer portion 712 is greater than the depth of the depressions 711, the depressions 711 disappear and it becomes impossible to form diffusing dots in the light guide plate according to a designed dot pattern. If a light guide plate is manufactured with a mold in which no depressions 711 are present, the diffusing dots 111 are buried in the irregularities on the rough surface 112, and the diffusing dots 111 cannot function as designed.

In the present embodiment, the cut depth employed in the grinding process using the flat-surface grinding machine (0.01 mm) is set shallower than the depth of the depressions 711. This is because if the cut depth in the grinding process is set deeper than the depth of the depressions 711, the depressions 711 disappear as a result of the grinding, and it becomes impossible to form diffusing dots in the light guide plate according to the designed dot pattern.

In the present embodiment, the cut depth in dressing the grinding wheel used for the grinding process with the flat-surface grinding machine (0.01 mm) is set shallower than the depth of the depressions 711. This is because if the grinding wheel is dressed by a depth deeper than that of the depressions 711, the surface roughness of the ground rough surface transfer portion 712 becomes so large that the depressions 711 disappear.

In the present embodiment, the depressions 711 are formed in a circular shape by etching. Accordingly, if the cut depth in the grinding process is equal to or less than half the depth of the depressions 711, the difference in the dot areas before and after the grinding process can be suppressed to a small degree. Therefore, in the present embodiment, the cut depth in the grinding process (0.01 mm) is set to approximately half the shallowest depth of the depression 711 (0.02 mm). If the cut depth in the grinding process is increased, the area of the depressions 711 significantly varies, and diffusing dots in the light guide plate cannot be formed according to the designed dot pattern.

### Method for Manufacturing the Light Guide Plate

Next, a process for manufacturing the light guide plate 110 using the light guide plate forming mold 700 manufactured in the above-described manner is described.

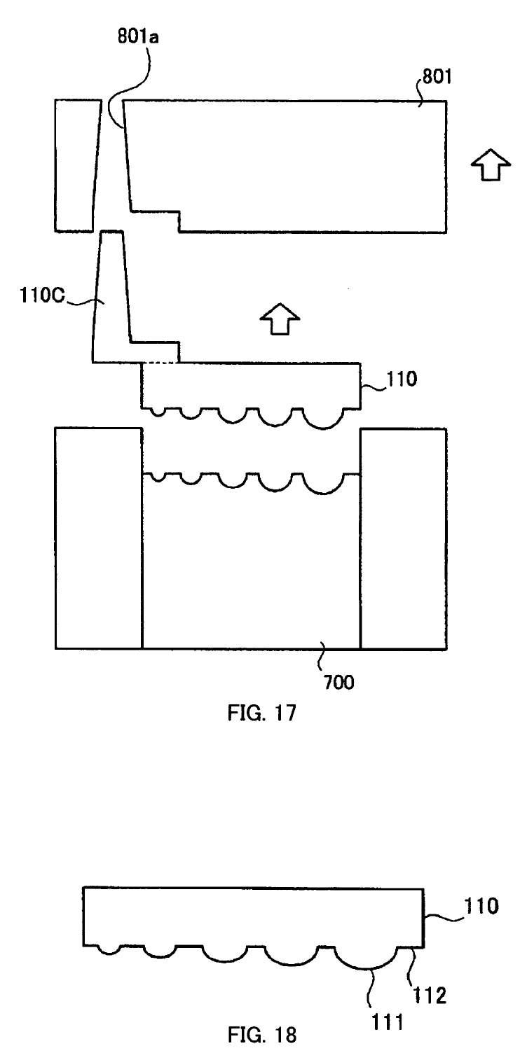

FIGS. 16 and 17 are diagrams illustrating manufacturing process of the light guide plate 110. FIG. 18 is a side view showing the manufactured light guide plate 110. In FIGS. 16 to 18, the shape of the molding surface 710 of the light guide plate forming mold 700 is not shown. First, as shown in FIG. 16, an upper mold 801 in which an injection gate 801a is formed, side molds 802 and 803, and the light guide plate forming mold 700 are assembled as appropriate. Then a resin material in a plasticization state is injected for filling from an injection tube 804. The molds 700, 801 to 803 are cooled to solidify the filled resin material.

Next, as shown in FIG. 17, for example, the upper mold 801 is removed in the direction of the white arrow in FIG. 17, and then the light guide plate 110 including a runner 110C is removed from the mold in the direction of the white arrow in FIG. 17. The runner 110C is separated by cutting to obtain the light guide plate 110 including the diffusing dots 111 and the rough surface 112, as shown in FIG. 18.

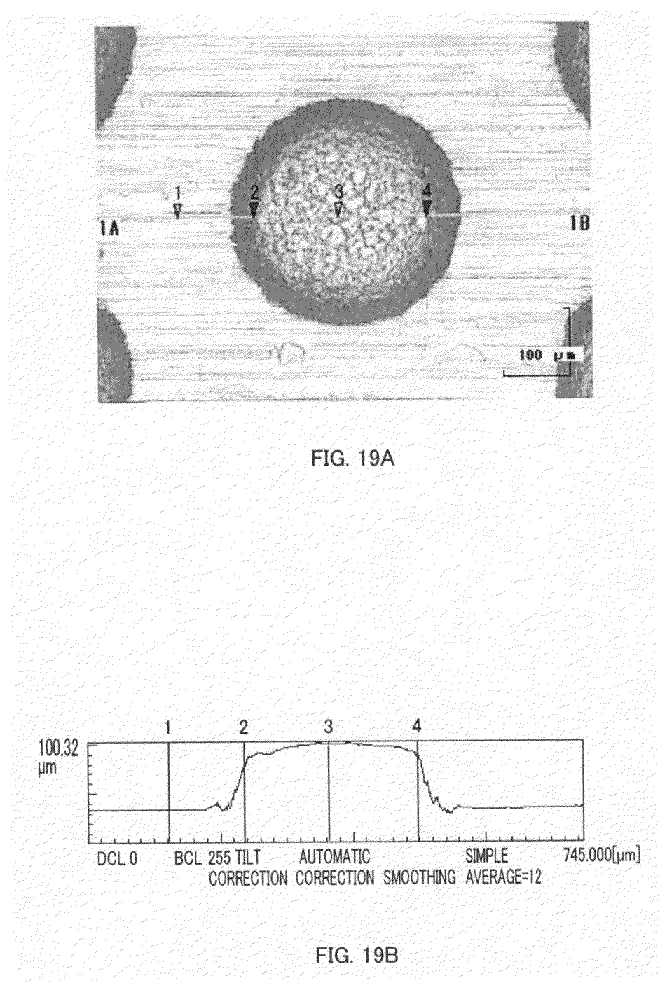

FIGS. 19A and 19B are explanatory diagrams of the shape of the diffusing dots 111. FIG. 19A is a picture of a diffusing dot, and FIG. 19B is a graph showing measurement results of the height along the line 1A-1B in FIG. 19A. Since an appropriate rough surface is formed in the diffusing dot transfer depression 711 of the mold by etching, such an appropriate rough surface is also formed on the surface of the diffusing dot 111.

Although the light guide plate 110 manufactured using the above-described light guide plate forming mold 700 is configured to have the diffusing dots 111 and the rough surface 112 on the light reflecting surface 110B side, they may be also formed on the light emission surface 110A side, for example. It is also possible to form only the rough surface 112 on the light emission surface 110A side. In this case, specifically, a rough surface may be formed by a grinding process on the processed surface of the upper mold 801, which is transferred to the light guide plate 110 when forming the same.

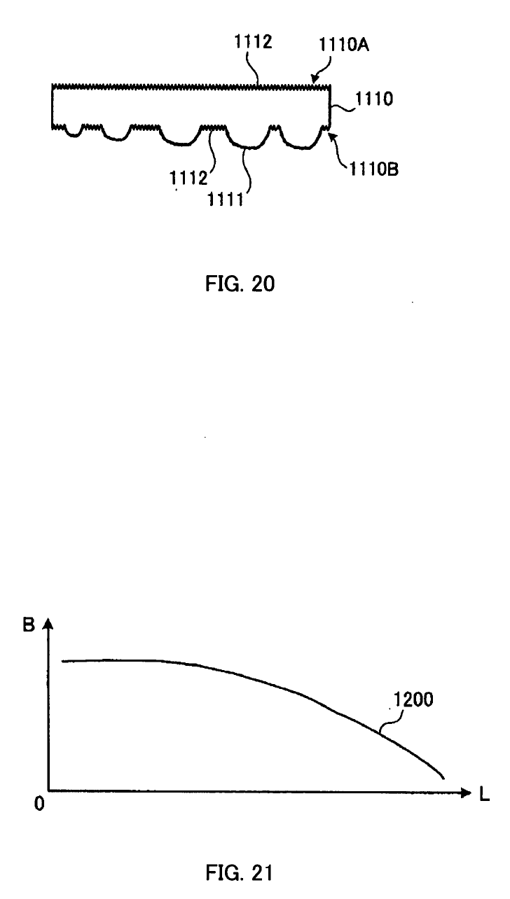

FIG. 20 is a side view showing another light guide plate. When a rough surface is formed on the processed surface of the upper mold 801 and transferred as described above, it is possible to obtain a light guide plate 1110 that has a rough surface 1112 on the light emission surface 1110A side and diffusing dots 1111 and the rough surface 1112 on a light reflecting surface 1110B side. Conditions for forming these diffusing dots 1111 and the rough surfaces 1112 can be set similarly to those for the above-described light guide plate 110. In this manner, these light guide plates 110 and 1110 respectively include diffusing dots 111 and 1111 that have a minute rough surface, and rough surfaces 112 and 1112 formed between the diffusing dots 111 or the diffusing dots 1111. For this reason, compared with conventional light guide plates which attempt to improve brightness by the formation of a rough surface and a mirror-finished surface, or by the arrangement of dots, the light guide plate of the present invention can further improve brightness by combining these diffusing dots 111 and 1111 with the rough surfaces 112 and 1112, while securely suppressing the occurrence of uneven brightness, which is a defect of conventional light guide plates, with the diffusing dots 111 and 1111, and the rough surfaces 112 and 1112.

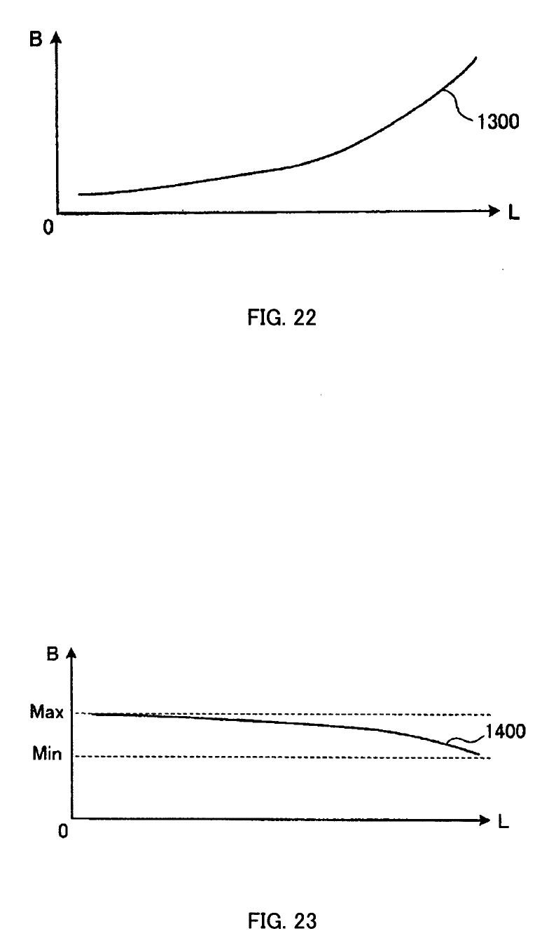

FIGS. 21 and 22 are graphs showing the relation between a brightness B and a relative position L when the position of the light source 106 is assumed to be “0” in an ordinary light guide plate. FIG. 23 is a graph showing the relation between the brightness B and the relative position L when the position of the light source 106 is assumed to be “0” in the light guide plate 110 of the present invention. As shown in FIG. 21, when the grinding process is performed on an ordinary light guide plate to form the rough surface 112 on at least one surface, the brightness B decreases as the relative position L from the light source 106 becomes greater, as shown by the curve 1200. Therefore, the brightness B is not uniform.

Accordingly, it is possible to achieve a uniform brightness B by combining the diffusing dots 111, which are formed in a pattern on at least one surface of an ordinary light guide plate such that the brightness B increases as the relative position L from the light source 106 becomes greater, as shown by the curve 1300 in FIG. 22. Accordingly, as shown in FIG. 23, in the case of the light guide plate 110 of the present embodiment, regardless of the relative position L from the light source 106, it is possible to obtain a stable light emission amount through the entire scope from a brightness Min to a brightness Max, as shown by the curve 1400. At this time, the ratio brightness Min/brightness Max is preferably equal to or more than 80%.

When the dot diameter on the light source side is set too large in the design of the dot pattern, while the brightness per effective light emission surface is improved, the amount of light that reaches the side opposite to the light source is reduced, and as a result the brightness uniformity deteriorates. On the other hand, when the dot diameter on the light source side is set to the minimum value, and the dot diameter on the side opposite to the light source is set to a small value, although brightness uniformity can be adjusted, the emission efficiency decreases and the average brightness also decreases. Therefore, when designing the dot pattern, the dot diameter on the side opposite to the light source is set to the maximum value, and then a dot diameter on the light source side that can improve the brightness uniformity and average brightness is determined.

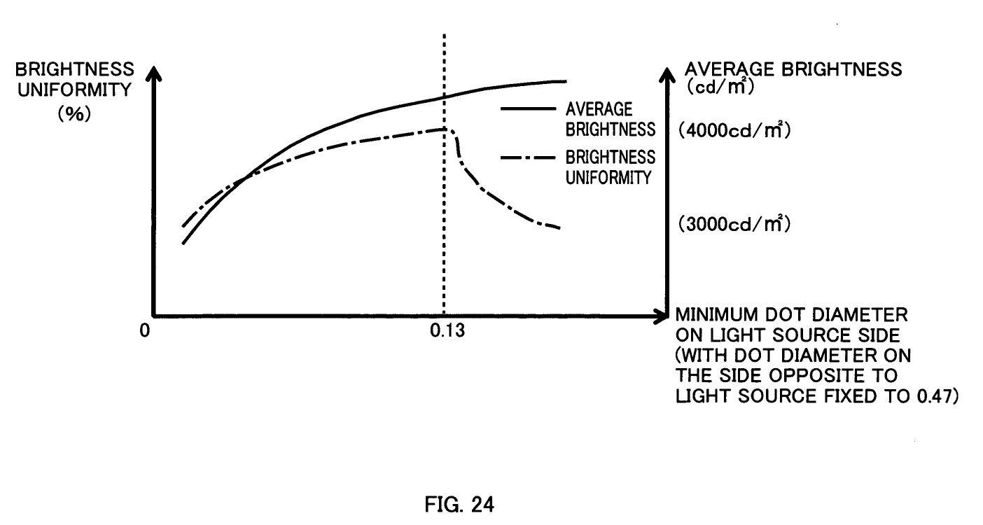

FIG. 24 is a graph showing the brightness uniformity and the average brightness of the light guide plate. The horizontal axis of the graph shows the diameter of the diffusing dots on the light source side (smallest dots). Here, the dot diameter on the side opposite to the light source is set to 0.47 mm. The vertical axis on the right side of the graph indicates the average brightness, and the vertical axis on the left side indicates the brightness uniformity. The brightness uniformity as used herein means the magnitude of the minimum brightness with respect to the maximum brightness. The solid line graph shows the average brightness and the dashed-line graph shows the brightness uniformity. Note that since the average brightness and brightness uniformity achieved by a dot pattern are examined here, a rough surface due to a grinding process is not formed.

As shown by the solid line graph, the average brightness increases as the dot diameter on the light source side increases. This is because as the dot diameter on the light source side increases, the total amount of light that reaches the diffusing dots increases, which improves the emission efficiency. When the dot diameter on the light source side is equal to or less than 0.13 mm, the brightness uniformity improves as the dot diameter on the light source side increases. It seems that when the dot diameter on the light source side is equal to or less than 0.13 mm, uneven brightness occurs which makes the side opposite to the light source brighter. On the other hand, when the dot diameter on the light source side exceeds approximately 0.13 mm, the brightness uniformity deteriorates as the dot diameter on the light source side increases. It should be noted that when the dot diameter on the light source side exceeds 0.13 mm, uneven brightness occurs which makes the light source side brighter.

In the present embodiment, the dot diameter on the light source side is set to 0.13 mm in order to improve the average brightness while maintaining the brightness uniformity.

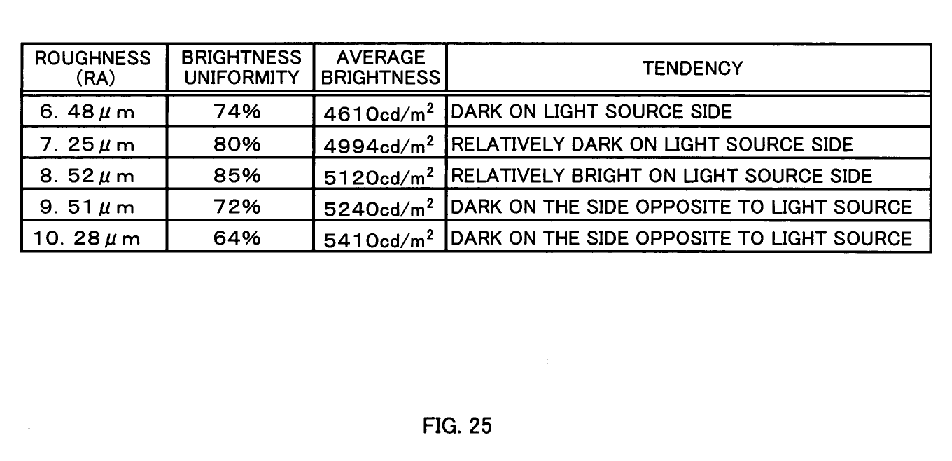

FIG. 25 is a table showing test results of brightness uniformity and average brightness. Here, the maximum dot diameter (dot diameter on the side opposite to the light source) is set to 0.47 mm, the minimum dot diameter (dot diameter on the light source side) is set to 0.13 mm, and the surface roughness Ra of the rough surface 112 is varied. As the surface roughness Ra increases, the average brightness increases. This is because the emission efficiency improves as the surface roughness Ra increases. On the other hand, as the surface roughness Ra increases, the light source side becomes brighter and the side opposite to the light source darker. This is because as the surface roughness Ra increases, a larger amount of light is reflected on the light source side, and the amount of light that reaches the side opposite to the light source decreases.

According to experiments by the present applicant, the following results were obtained. Mean brightness (average brightness) and uneven brightness (brightness uniformity) of the light guide plates 110 were compared with light guide plates in which only one of the diffusing dot 111 and the rough surface 112 is formed on the light emission surface 110A or the light reflecting surface 110B, and light guide plates formed by combining these, under the common conditions that a cold cathode tube (Ø1.8) is used as the light source 106 of the light guide plate 110, and the thickness of the light guide plate is 2.15 mm.

The results of the former light guide plates are a mean brightness of 3,780 cd/m² and an uneven brightness of 81.5%. The results of the latter light guide plates are a mean brightness of 4,994 cd/m² and an uneven brightness of 80.0%. Accordingly, the light guide plate 110 manufactured by combining the diffusing dot 111 and the rough surface 112 improved the brightness approximately by 1.3 times compared with the light guide plates 110 in which only one of them is formed, while the uneven brightness of the two light guide plates showed similar results. Therefore, with the light guide plate 110 of the present invention, the emission efficiency can be stably improved.

As described so far, with the light guide plate 110 of the present invention, on at least one of the light emission surface 110A and the light reflecting surface 110B of the light guide plate 110, a plurality of diffusing dots 111 having a concave or convex shape for diffusing light, and a rough surface 112 formed over an entire surface between a plurality of the diffusing dots 111 so as to have a substantially uniform surface roughness are provided. In this manner, light that enters the light guide plate 110 is emitted to the light emission side as a result of being diffused by a plurality of diffusing dots 111 and the rough surface 112 formed between the diffusing dots 111. Therefore, compared with a conventional light guide plate including a rough surface and a mirror-finished surface, which attempts to improve the emission efficiency by simply arranging or forming dots or a rough surface, the emission efficiency of light from the light source 106 can be stably improved.

In addition, since the concave or convex surfaces of a plurality of diffusing dots 111 are respectively roughened so as to have a plurality of minute irregularities formed by etching for example, light incident on the light guide plate 110 can be diffused efficiently. Furthermore, since the density of a plurality of the diffusing dots 111 per unit area increases from the closer side to the distant side with respect to the light source 106, the amount of light that is emitted from the vicinity of the light source 106 and that from a portion distant from the light source 106 can be made uniform, and so-called uneven brightness can be suppressed.

Since a plurality of diffusing dots 111 have a circular (hemispheric) shape designed subject to the above numerical value range, it becomes possible to easily improve the emission efficiency by the diffusing dot 111, while allowing for flexibility in designing a pattern of the diffusing dots 111 of the light guide plate 110. Further, since the rough surface 112 is formed to have a surface roughness Ra of substantially equal to or less than 10 μm, the rough surface 112 of the light guide plate 110 can be formed in a uniform manner based on the surface roughness. At the same time, it becomes possible to easily design a pattern of the diffusing dots 111 based on the surface roughness Ra of the rough surface 112, while attempting to improve the emission efficiency by the rough surface 112.

With the light guide plate forming mold 700 of the present embodiment, a plurality of diffusing dot transfer depressions 711 having a concave or convex shape for diffusing light, and the rough surface transfer portion 712 formed over an entire surface between the diffusing dot transfer depressions 711 so as to have a substantially uniform surface roughness are formed on a processed surface to be used for forming at least the light reflecting surface 110B of the light guide plate 110. Consequently, light that enters the light guide plate 110 formed using the light guide plate forming mold 700 is emitted from the light emission side as a result of being diffused by a plurality of diffusing dots 111 formed by a plurality of diffusing dot transfer depressions 711, and the rough surface 112 formed by the rough surface transfer portion 712. Therefore, it becomes possible to manufacture a light guide plate 110 capable of improving the emission efficiency of light from the light source 106 in a stable manner, compared with a conventional mold for forming a light guide plate that includes a rough surface and a mirror-finished surface.

Also, since concave or convex surfaces of a plurality of diffusing dot transfer depressions 711 are respectively roughened so as to have a plurality of minute irregularities, it becomes possible to diffuse incident light in an efficient manner by the diffusing dots 111 of the light guide plate 110 formed by the diffusing dot transfer depressions 711. Furthermore, since the density of a plurality of diffusing dot transfer depressions 711 on the processed surface gradually increases from one end of the processed surface to the other end thereof, in the light guide plate 110 manufactured using the diffusing dot transfer depressions 711, the amount of light that is emitted from the vicinity of the light source 106 and that from a portion distant therefrom can be made uniform, and uneven brightness can be suppressed.

In addition, since a plurality of diffusing dot transfer depressions 711 for forming a plurality of diffusing dots 111 of the light guide plate 110 have a circular (hemispheric) shape designed subject to the above numerical value range, it becomes possible to easily improve the emission efficiency by the diffusing dots 111 in the light guide plate 110 manufactured using the diffusing dot transfer depressions 711. Further, since the rough surface transfer portion 712 for forming the rough surface 112 is formed so as to have a surface roughness Ra of substantially equal to or less than 10 μm, the rough surface 112 of the light guide plate 110 formed using the rough surface transfer portion 712 can be formed in a uniform manner based on the surface roughness. At the same time, it becomes possible to easily design a pattern of diffusing dots 111 based on the surface roughness Ra of the rough surface 112, while attempting to improve the emission efficiency by the rough surface 112.

Also with a method for manufacturing the light guide plate forming mold 700 of the present embodiment, a plurality of diffusing dot transfer depressions 711 in a concave or convex shape are formed by etching or casting on the surface of a metallic base material to be used for forming at least the light reflecting surface 110B of the light guide plate 110, and the rough surface transfer portion 712 is formed that has a substantially uniform surface roughness by grinding or blasting over the entire surface between a plurality of the diffusing dot transfer depressions 711. In this manner, it is possible to obtain the light guide plate forming mold 700 with a plurality of diffusing dot transfer depressions 711 and the rough surface transfer portion 712 formed on the surface thereof. By using the light guide plate forming mold 700, it is possible to manufacture the light guide plate 110 capable of stably improving the emission efficiency of incident light.

Furthermore, with the method for manufacturing the light guide plate 110 of the present embodiment, by injection molding using the light guide plate forming mold 700 manufactured by the above-described method for manufacturing the light guide plate forming mold 700, it becomes possible to obtain the light guide plate 110 capable of stably improving the emission efficiency of incident light.

The foregoing embodiment is for the purpose of elucidating the present invention, and is not to be interpreted as limiting the present invention. The invention can of course be altered and improved without departing from the gist thereof, and includes functional equivalents.

What is claimed is:

1. A light guide plate comprising:
a lateral surface from which light from a light source enters;
a light emission surface from which the light is emitted; and
a light reflecting surface reflecting the light,
wherein at least one of the light emission surface and the light reflecting surface includes:
a plurality of first light diffusing portions for diffusing the light, which are formed in either one of a concave and convex shape in a thickness direction of the light guide plate; and
a second light diffusing portion that is formed having a uniform surface roughness over an entire surface between a plurality of the first light diffusing portions.

2. A light guide plate according to claim 1,
wherein the first light diffusing portions are convex and their height is greater than the surface roughness of the second light diffusing portion.

3. A light guide plate according to claim 1,
wherein the second light diffusing portion includes either one of concave and convex streaks extending in a direction perpendicular to a light guide direction.

4. A light guide plate according to claim 1,
wherein either one of concave and convex surfaces of a plurality of the first light diffusing portions are respectively roughened so as to have a plurality of minute irregularities.

5. A light guide plate according to claim 1,
wherein a plurality of the first light diffusing portions are formed such that a density of the first light diffusing portions per unit area increases from a closer side to a distant side with respect to the light source.

6. A light guide plate according to claim 1,
wherein when viewed in the plate thickness direction, each of a plurality of the first light diffusing portions is formed in a circular shape having a diameter in the range of substantially 0.1 mm to substantially 0.5 mm and a height of the vertex with respect to a surface on which the first light diffusing portions are formed in the range of substantially 0.02 mm to substantially 0.1 mm.

7. A light guide plate according to claim 1,
wherein the second light diffusing portion is formed so as to have a surface roughness Ra of substantially equal to or less than 10 μm.

8. A mold for forming a light guide plate, comprising:
a plurality of first light diffusing portion forming dots formed in either one of a concave and convex shape in a direction perpendicular to a surface direction; and
a second light diffusing portion forming rough surface formed having a uniform surface roughness over an entire surface between the first light diffusing portion forming dots,
wherein the light guide plate includes a lateral surface from which light from a light source enters, a light emission surface from which the light is emitted, and a light reflecting surface reflecting the light,
the first light diffusing portion forming dots and the second light diffusing portion forming rough surface are formed on a surface for forming at least one of the light emission surface and the light reflecting surface,
a plurality of the first light diffusing portion forming dots are for forming, in the light guide plate, first light diffusing portions for diffusing the light, and
the second light diffusing portion forming rough surface is for forming a second light diffusing portion between the first light diffusing portions of the light guide plate.

9. A mold according to claim 8,
wherein the first light diffusing portion forming dots are concave and their depth is greater than the surface roughness of the second light diffusing portion forming rough surface.

10. A mold according to claim 8,
wherein either one of concave and convex streaks are formed on the second light diffusing portion forming rough surface, the streaks extending in a direction perpendicular to a light guide direction in the light guide plate.

11. A mold according to claim 8,
wherein the second light diffusing portion forming rough surface is formed by a grinding process after the first light diffusing portion forming dots have been formed by etching.

12. A method for manufacturing a mold for forming a light guide plate having a lateral surface from which light from a light source enters, a light emission surface from which the light is emitted, and a light reflecting surface reflecting the light, the method comprising:
forming a plurality of either one of concave and convex first light diffusing portion forming dots in a direction perpendicular to a surface direction, in order to form first light diffusing portions for diffusing the light in the light guide plate; and
forming a second light diffusing portion forming rough surface having a uniform surface roughness over an entire surface between the first light diffusing portion forming dots, in order to form a second light diffusing portion between the first light diffusing portions of the light guide plate.

13. A method for manufacturing a mold according to claim 12,
wherein the first light diffusing portion forming dots are concave and their depth is greater than the surface roughness of the second light diffusing portion forming rough surface.

14. A method for manufacturing a mold according to claim 12,
wherein forming the second light diffusing portion forming rough surface is performed by forming either one of concave and convex streaks extending in a direction perpendicular to a light guide direction in the light guide plate.

15. A method for manufacturing a mold according to claim 12,
wherein forming the second light diffusing portion forming rough surface by a grinding process is performed after forming a plurality of the first light diffusing portion forming dots has been performed by etching.

16. A method for manufacturing a mold according to claim 15,
wherein a cut depth in the grinding process is shallower than a depth of the first light diffusing portion forming dots.

17. A method for manufacturing a mold according to claim 15,
wherein a cut depth in dressing a grinding wheel used for the grinding process is shallower than a depth of the first light diffusing portion forming dots.
